(19) United States
(12) Patent Application Publication
(10) Pub. No.: US 2005/0267873 A1
(43) Pub. Date: Dec. 1, 2005

(54) Method and system for dynamic article listing

(75) Inventors: Bjorn Kettner, Saarbrucken (DE); Brigitte Kuhn, Saarbrucken (DE); Jorg Klomfass, Saarbrucken (DE); Cornelia Behrendt-Schinke, Saarbrucken (DE)

Correspondence Address: FOLEY & LARDNER, 777 EAST WISCONSIN AVENUE, SUITE 3800, MILWAUKEE, WI, 53202-5308, US

(73) Assignee: SAP Aktiengesellschaft

(21) Appl. No.: 11/074,369

(22) Filed: Mar. 7, 2005

Related U.S. Application Data
(60) Provisional application No. 60/551,221, filed on Mar. 8, 2004.
(60) Provisional application No. 60/563,284, filed on Apr. 16, 2004.

(51) Int. Cl. G06F 17/30

(52) U.S. Cl. 707/3

(57) ABSTRACT

A method of using dynamic article lists in a computerized retail management system includes receiving a selection criterion configured for defining article lists from stored identifiers for a plurality of articles in the computerized retail management system and generating a first list of articles based on the selection criterion. The method also includes storing the selection criterion in the computerized retail management system. The first list of articles is not stored with the selection criterion. The stored selection criterion is configured to be retrieved in order to generate a second list of articles.

### CROSS-REFERENCE TO RELATED PATENT APPLICATIONS

This application claims the benefit of U.S. Provisional Application No. 60/551,221, filed Mar. 8, 2004 and entitled “Inventory Management,” and U.S. Provisional Application No. 60/563,284, filed Apr. 16, 2004 and entitled “Inventory Management,” both of which are hereby incorporated by reference.

### BACKGROUND

The present description relates generally to the field of management systems for products and services, and more specifically to methods and systems for managing lists of products and services.

Businesses providing products and services may typically generate and manage lists of the planned or available products and services within an automated management system. For some businesses, these lists may become overly complex and require excessively large volumes of data such that they may not be efficiently generated, stored and managed. There is need for a method and system for dynamic article listing that may be implemented in management systems for products and services to reduce the complexity and data volume associated with generating, storing and managing lists of products and services.

### SUMMARY

According to an exemplary embodiment, a method of using dynamic article lists in a computerized retail management system includes receiving a selection criterion configured for defining article lists from stored identifiers for a plurality of articles in the computerized retail management system and generating a first list of articles based on the selection criterion. The method also includes storing the selection criterion in the computerized retail management system. The first list of articles is not stored with the selection criterion. The stored selection criterion is configured to be retrieved in order to generate a second list of articles.

According to another exemplary embodiment, a retail management system includes means for receiving a selection criterion configured for defining article lists from identifiers stored in the retail management system for a plurality of articles, and means for generating a first list of articles based on the selection criterion. The system also includes means for storing the selection criterion. The first list of articles is not stored with the selection criterion. The stored selection criterion is configured to be retrieved in order to generate a second list of articles.

According to another exemplary embodiment, a program product for implementing dynamic article lists in a computerized retail management system includes machine-readable program code for causing, when executed, one or more machines to perform the steps of: receiving a selection criterion configured for defining article lists from stored identifiers for a plurality of articles in the computerized retail management system, generating a first list of articles based on the selection criterion, and storing the selection criterion in the computerized retail management system. The first list of articles is not stored with the selection criterion. The stored selection criterion is configured to be retrieved in order to generate a second list of articles.

Other features and advantages of the present invention will become apparent from the following detailed description and accompanying drawings. It should be understood, however, that the detailed description and specific examples are given by way of illustration and not limitation. Many modifications and changes within the scope of the present invention may be made without departing from the spirit thereof, and the invention includes all such modifications.

### BRIEF DESCRIPTION OF THE DRAWINGS

The exemplary embodiments will hereafter be described with reference to the accompanying drawings, wherein like numerals depict like elements, and:

FIG. 1 is a block diagram illustrating a data structure for implementing dynamic article lists in a retail management system according to an exemplary embodiment;

FIG. 2 illustrates a graphical user interface screen configured to facilitate implementation of an article list hierarchy structure according to an exemplary embodiment;

FIG. 3 illustrates another graphical user interface screen configured to facilitate implementation of dynamic article lists according to an exemplary embodiment;

FIG. 4 illustrates a graphical user interface screen configured to facilitate determination of dynamic article list selection criteria according to an exemplary embodiment; and

FIG. 5 is a flow diagram illustrating a method of using dynamic article lists in a retail management system according to an exemplary embodiment.

### DETAILED DESCRIPTION

In the following description, for the purposes of explanation, numerous details are set forth in order to provide a thorough understanding of the present invention. It will be evident to one skilled in the art, however, that the exemplary embodiments may be practiced without these specific details. In other instances, structures and device are shown in diagram form in order to facilitate description of the exemplary embodiments. Further, while the method and system is described primarily in the context of retail management systems for retail products and articles, it should be understood that the method and system are applicable in other contexts, including management systems for service providers.

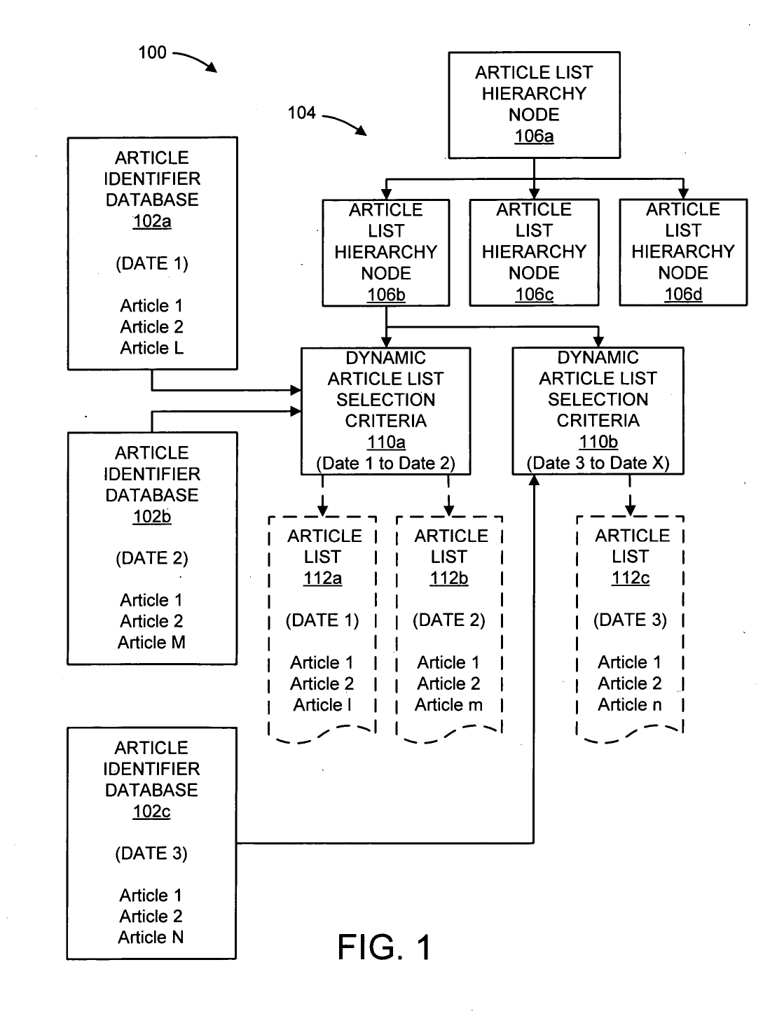

FIG. 1 is a block diagram illustrating a data structure 100 for implementing dynamic article lists in a retail management system according to an exemplary embodiment. Structure 100 includes a database of article identifiers 102, an article list hierarchy structure 104 including one or more nodes 106 (e.g., nodes 106a-106d), and one or more dynamic article list selection criteria 110 configured for defining article lists 112 associated with at least one of the nodes in product hierarchy structure 104. Structure 100 may generally be used to facilitate generation and association of article lists 112 having identifiers in database 102 with one or more nodes in article list hierarchy structure 104. More specifically, structure 100 may be used to facilitate generation of article lists 112 based on dynamic article list selection criteria 110. The resultant article lists are not stored with the selection criteria 110, and may vary in content for the same selection criteria 110 depending on the date of generation. The term “dynamic article list” as used herein refers to stored dynamic article list selection criteria 110 and other associated data used to generate one or more article lists 112 that are not stored with the dynamic article list selection criteria 110. The term “static article list” refers to a stored list of articles that are stored either with or without selection criteria used to determine the list.

Database 102 includes identifiers for a plurality of articles and may be any suitable type of database. Each identifier for an article may be numeric, text, etc. in any of a number of suitable data formats. In addition to an identifier for each article, database 102 may also include additional data for each article, such as, for example, a short description of the article, a generic article number, an assigned merchandise group, an article type indicator, an article category indicator, etc.

The number of article identifiers contained in database 102 may vary on a temporal basis such that database 102 may contain the same, additional, fewer, or different article identifiers from one date to the next. For example, in FIG. 1, database 102a represents the article identifiers contained in database 102 on “Date 1” (e.g., Articles 1, 2, . . . , L). Database 102b represents the article identifiers contained in database 102 on “Date 2” (e.g., Articles 1, 2, . . . , M). Database 102c represents the article identifiers contained in database 102 on “Date 3” (e.g., Articles 1, 2, . . . , N). Databases 102b and 102c may contain the same, additional, fewer, or different article identifiers from those contained in database 102a on Date 1 depending on, for example, added articles, deleted articles, replacement articles, etc. in the retail management system.

Article list hierarchy structure 104 is a data structure comprising multiple levels of abstraction which may be used to group an aggregation of article lists hierarchically in a theme oriented structure. Article list hierarchy structure 104 includes a plurality of nodes 106 (e.g., nodes 106a-106d). A single node in article list hierarchy 104 comprises the top node. For example, in FIG. 1, node 106a is the top node. With the exception of the top node, each node 106 is assigned to just one other node 106 in article hierarchy structure 104. Nodes 106 that have no other nodes assigned to them are end nodes. For example, in FIG. 1, nodes 106b, 106c, and 106d are end nodes.

Each node 106 may be associated with one or more dynamic article list selection criteria 110 in order to define one or more article lists 112 associated with the node 106. For example, in FIG. 1, dynamic article list selection criteria 110a are associated with node 106b such that article lists 112a and 112b are associated with node 106a depending on the current date. On Date 1, article list 112a is associated with node 106a, and on Date 2, article list 112b is associated with node 106a. According to an exemplary embodiment, a particular set of dynamic article list selection criteria 110 may be assigned to a particular node 106 (e.g., end nodes 106b or 106c) and then later reassigned to a different node (e.g., node 106a). According to another exemplary embodiment, several different sets of dynamic article list selection criteria 110 may be assigned to a single node 106. For example, in FIG. 1, dynamic article list selection criteria 110a and 110b are both assigned to node 106b and stored as dynamic article lists.

Dynamic article list selection criteria 110 include stored selection criteria that are configured to determine article lists 112 as a subset of article identifiers in database 102. For example, as shown in FIG. 1, applying dynamic article list selection criteria 110a to Articles 1, 2, . . . , L in database 102a on Date 1 results in article list 112a, which includes Articles 1, 2, . . . , 1 as a subset of Articles 1, 2, . . . , L. Any suitable selection criteria may be used for dynamic article list selection criteria 110. According to an exemplary embodiment, dynamic article selection criteria 110 include an associated material group hierarchy or material group, article category, article type, article number, purchasing group, purchasing organization, supplier, vendor, sales organization, sales channel, retail site, storage location, storage number, storage type, and article hierarchy.

Applying the same set of dynamic article list selection criteria 110 on different dates may result in different article lists 112. For example, as shown in FIG. 1, applying dynamic article list selection criteria 110a to Articles 1, 2, . . . , M in database 102b on Date 2 results in article list 112b, which includes Articles 1, 2, . . . , m as a subset of Articles 1, 2, . . . , M. Articles 1, 2, . . . , m may include the same, additional, fewer, or different articles than Articles 1, 2, . . . , 1 included in article list 112a on Date 1 depending on, for example, added articles, deleted articles, replacement articles, etc. in the retail management system.

According to an exemplary embodiment, dynamic article list selection criteria 110 are assigned to a particular node 106 for a temporal validity period which may be any suitable duration. For example, as show in FIG. 1, dynamic article list selection criteria 110a have an assigned validity period from Date 1 to Date 2 during which they are validly assigned to node 106b. Accordingly, dynamic article list selection criteria 110a are applied to article identifiers stored in database 102 from Date 1 to Date 2. Dynamic article list selection criteria 110b have an assigned validity period from Date 3 to Date X during which they are validly assigned to node 106b as opposed to dynamic article list selection criteria 110a. Accordingly, dynamic article list selection criteria 110b are assigned to node 106b and applied to article identifiers stored in database 102 from Date 3 to Date X. For example, on Date 3, dynamic article list selection criteria 110b are applied to database 102c, resulting in article list 112c, which includes Articles 1, 2, . . . , n as a subset of Articles 1, 2, . . . , N in database 102c. According to an exemplary embodiment, the temporal validity period is at least two days.

Article lists 112 are temporary subset listings of articles for which identifiers exist in database 102 and which depend on dynamic article list selection criteria 110 and the articles for which identifiers exist in database 102 on the date that the selection criteria 110 are applied. Accordingly, several potential article lists 112 exist for each set of dynamic article list selection criteria 110 depending on the date that the selection criteria 110 are applied. Article lists 112 are temporary in the sense that they are not saved with dynamic article list selection criteria 110. Instead, each article list 112 is deleted after use and a new article list 112 is generated for dynamic article list selection criteria 110 on a new date as required.

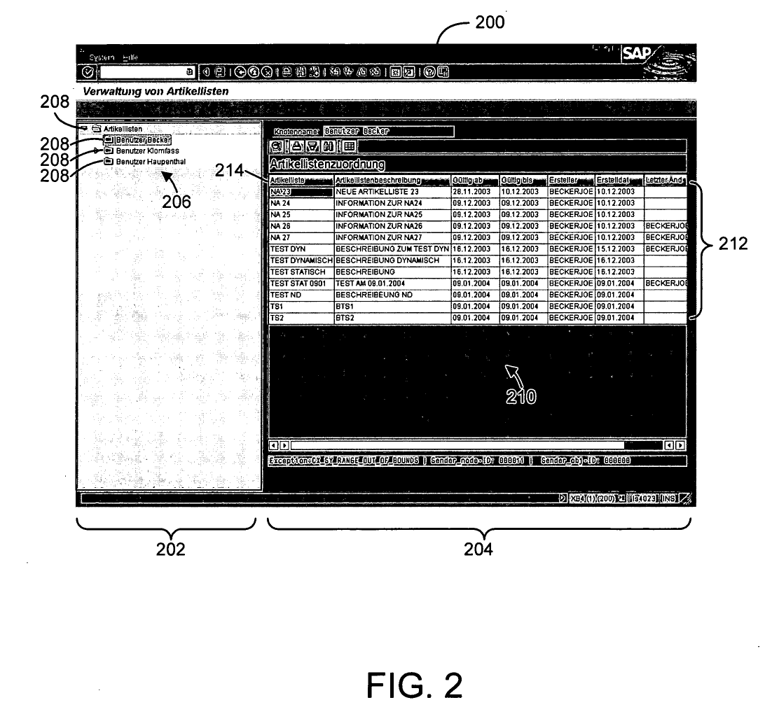

FIG. 2 illustrates a graphical user interface screen 200 configured to facilitate implementation of an article list hierarchy structure according to an exemplary embodiment. In the illustrated embodiment, screen 200 is partitioned into an area 202 and an area 204. An article list hierarchy structure is displayed in area 202 as a tree structure 206 having various nodes 208 which represent nodes in the article list hierarchy structure. In addition, a name for each node 208 is displayed adjacent to the node. Selecting a node 208 (e.g., with a mouse command, etc.) from tree structure 206 causes a list 210 to be displayed in area 204. List 210 includes rows 212 that include an identifier 214 and other associated data for all dynamic article lists, as well as any static article lists associated with the selected node.

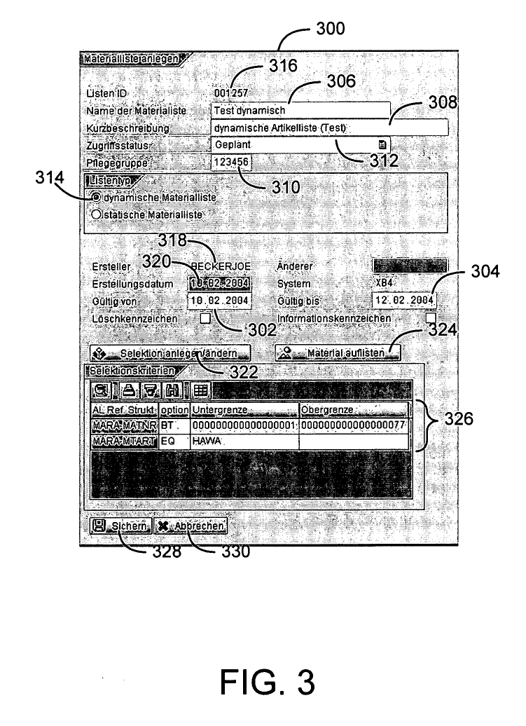

FIG. 3 illustrates a graphical user interface screen 300 which is configured to facilitate the creation of dynamic article lists according to an exemplary embodiment. In a field 302 and a field 304 of screen 300, a user enters beginning and ending dates for a temporal validity period associated with a dynamic article list. In a field 306 of screen 300, the user enters a name for the dynamic article list. In a field 308 of screen 300, the user enters a short description of the dynamic article list. In a field 310 of screen 300, the user enters a maintenance group for the dynamic article list. The maintenance group is used to determine what other information in addition to article identifiers will be included for each article that satisfies the selection criteria defined for the dynamic article list. According to an exemplary embodiment, a default maintenance group is provided which includes the merchandise group, article type, article category, article description, and generic article number in addition to the article identifier for each article that satisfies the selection criteria. The user may also limit access to the dynamic article list information using a field 312. The user selects button 314 to indicate that a dynamic article list is being created rather than a static article list. Once this information is provided by the user, screen 300 displays an internally generated ID number for the dynamic article list in a field 316. Screen 300 also displays the name of the creator of the dynamic article list in a field 318, and displays the date the dynamic article list was created in a field 320.

Screen 300 also includes button 322 which is selected by the user in order to access a screen configured to facilitate definition of dynamic article list selection criteria. Once the dynamic article list selection criteria are selected by the user, the user may select button 324 of screen 300 to display the resulting article list in an area 326 of screen 300. The dynamic article list selection criteria and the other data entered in screen 300 may be saved by the user by selecting button 328, or deleted by selecting button 330.

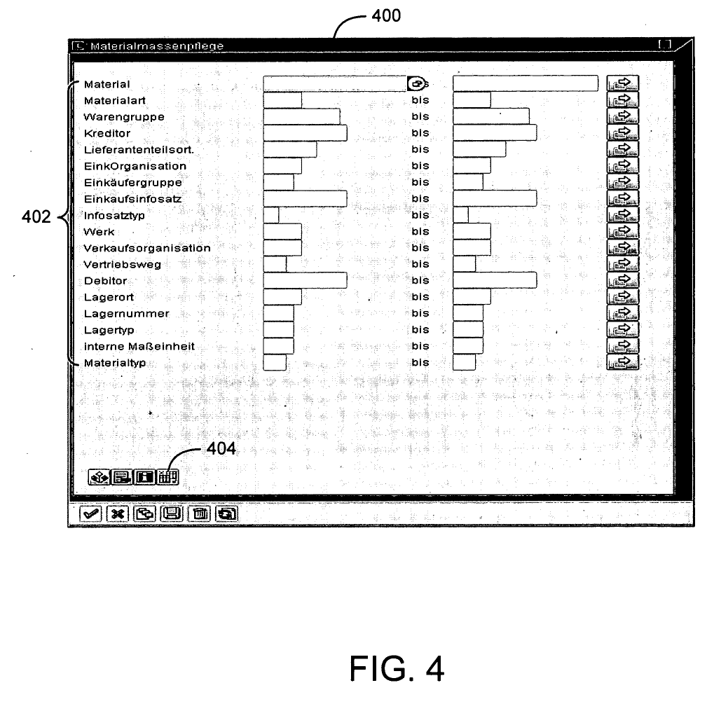

FIG. 4 illustrates a graphical user interface screen 400 configured to facilitate determination of dynamic article list selection criteria according to an exemplary embodiment. Screen 400 includes default selection criteria 402 for which values may be entered. The user may use button 404 to add selection criteria, or to change or delete any of default selection criteria 402.

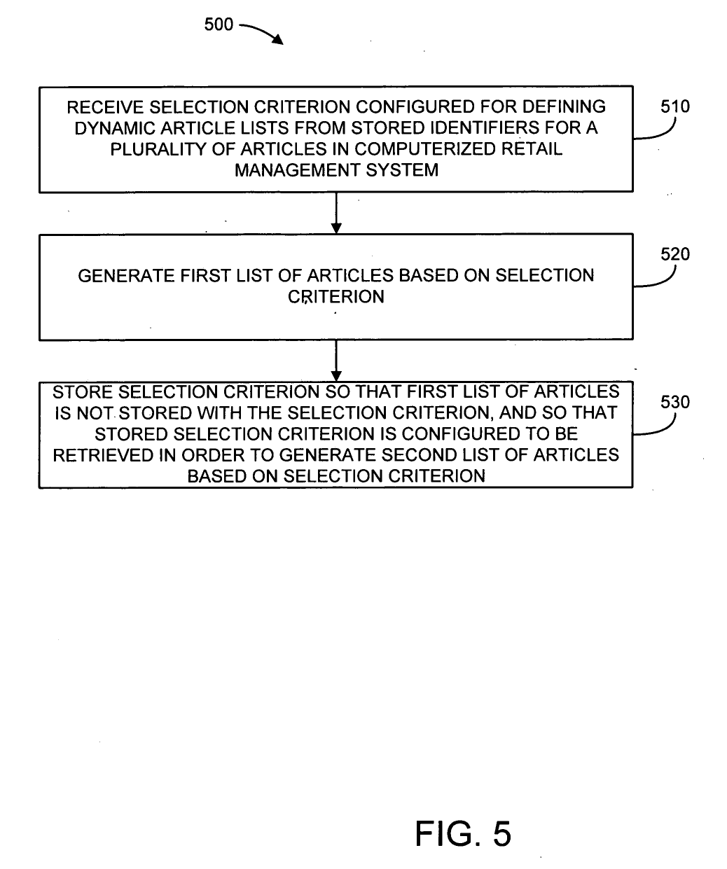

FIG. 5 is a flow diagram illustrating a method 500 of using dynamic article lists in a retail management system according to an exemplary embodiment. Method 500 begins with a step 510. In step 510, at least one selection criterion for defining dynamic article lists from stored identifiers for a plurality of articles is received in a computerized retail management system. For example, selection criteria 110a (shown in FIG. 1) may be received by the retail management system from a user via graphical user interface screens 200, 300, and 400 (shown in FIGS. 2, 3, and 4). In a step 520, a first list of articles is generated in the retail management system based on the selection criterion. For example, article list 112a (shown in FIG. 1) may be generated from selection criteria 110a received in step 510 using screen 300. In a step 530, the selection criterion is stored in the computerized retail management system. The first list of articles is not stored with the selection criterion. For example, selection criteria 110a received in step 510 may be saved in the retail management system in response to a user selecting button 328 in screen 300, while the resulting article list is deleted. The stored selection criterion is configured to be retrieved in order to generate a second list of articles based on the selection criterion. For example, stored selection criteria 110a may be retrieved on Date 2 in order to generate article list 112b.

In this way, the method and system for dynamic article listing may be used in a retail management system to generate updated article lists for the same set of stored selection criteria while reducing storage requirements associated with the article listing. The method and system for dynamic article listing may thus reduce the complexity and data volume associated with generating, storing and managing lists of products and services.

Embodiments within the scope of the present description include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also to be included within the scope of computer-readable media. Computer-executable instructions comprise, for example, instructions and data which cause a general purpose computer, special purpose computer, or special purpose processing device to perform a certain function or group of functions.

The methods described herein may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

The method and system in some embodiments may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The method and system may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the system might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

Software and web implementations could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

1. A method of using dynamic article lists in a computerized retail management system, comprising:
receiving a selection criterion configured for defining article lists from stored identifiers for a plurality of articles in the computerized retail management system;
generating a first list of articles based on the selection criterion; and
storing the selection criterion in the computerized retail management system, wherein the first list of articles is not stored with the selection criterion, and wherein the stored selection criterion is configured to be retrieved in order to generate a second list of articles.

2. The method of claim 1, further comprising:
retrieving the stored selection criterion; and
generating the second list of articles.

3. The method of claim 2, wherein the second list of articles is different from the first list of articles.

4. The method of claim 1, wherein the stored selection criterion is associated with a node in an article list hierarchy.

5. The method of claim 4, wherein the stored selection criterion has an associated temporal validity period.

6. The method of claim 5, wherein receiving the selection criterion comprises receiving first and second sets of selection criteria, and wherein the first and second sets of selection criteria are associated with the node.

7. The method of claim 1, wherein receiving the selection criterion comprises receiving the selection criterion from a graphical user interface.

8. The method of claim 1, wherein storing the selection criterion in the computerized retail management system includes deleting the first list of articles.

9. A retail management system, comprising:
means for receiving a selection criterion configured for defining article lists from identifiers stored in the retail management system for a plurality of articles;
means for generating a first list of articles based on the selection criterion; and
means for storing the selection criterion, wherein the first list of articles is not stored with the selection criterion, and wherein the stored selection criterion is configured to be retrieved in order to generate a second list of articles.

10. The retail management system of claim 9, further comprising:
means for retrieving the stored selection criterion; and
means for generating the second list of articles.

11. The retail management system of claim 10, wherein the second list of articles is different from the first list of articles.

12. The retail management system of claim 9, wherein the stored selection criterion is associated with a node in an article list hierarchy.

13. The retail management system of claim 12, wherein the stored selection criterion has an associated temporal validity period.

14. The retail management system of claim 13, wherein means for receiving the selection criterion is configured to receive first and second sets of selection criteria associated with the node.

15. The retail management system of claim 9, wherein the means for receiving the selection criterion comprises a graphical user interface.

16. The retail management system of claim 9, wherein the means for storing the selection criterion is further configured to delete the first list of articles.

17. A program product for implementing dynamic article lists in a computerized retail management system, the program product comprising machine-readable program code for causing, when executed, one or more machines to perform the following method steps:
receiving a selection criterion configured for defining article lists from stored identifiers for a plurality of articles in the computerized retail management system;
generating a first list of articles based on the selection criterion; and
storing the selection criterion in the computerized retail management system, wherein the first list of articles is not stored with the selection criterion, and wherein the stored selection criterion is configured to be retrieved in order to generate a second list of articles.

18. The program product of claim 17, wherein the machine-readable program code is further configured to cause, when executed, the one or more machines to perform the following method steps:
retrieving the stored selection criterion; and
generating the second list of articles.

19. The program product of claim 18, wherein the second list of articles is different from the first list of articles.

20. The program product of claim 17, wherein the stored selection criterion is associated with a node in an article list hierarchy.

21. The program product of claim 20, wherein the stored selection criterion has an associated temporal validity period.

22. The program product of claim 21, wherein receiving the selection criterion comprises receiving first and second sets of selection criteria, and wherein the first and second sets of selection criteria are associated with the node.

23. The program product of claim 17, wherein receiving the selection criterion comprises receiving the selection criterion from a graphical user interface.

24. The program product of claim 17, wherein storing the selection criterion in the computerized retail management system includes deleting the first list of articles.
